(19) United States
(12) Patent Application Publication
(10) Pub. No.: US 2020/0043045 A1
(43) Pub. Date: Feb. 6, 2020

(54) MULTIDIMENSIONAL PRIVACY CONTROL

(71) Applicant: Walmart Apollo, LLC, Bentonville, AR (US)

(72) Inventors: Joseph JURICH, JR., Molino, FL (US); Christopher Mark JOHNSON, Bella Vista, AR (US)

(21) Appl. No.: 16/451,431

(22) Filed: Jun. 25, 2019

Related U.S. Application Data
(60) Provisional application No. 62/714,652, filed on Aug. 3, 2018.

(51) Int. Cl. G06Q 30/02; G06Q 20/36

(52) U.S. Cl. CPC G06Q 30/0257; G06Q 30/0264; G06Q 20/363

(57) ABSTRACT

Systems and methods are disclosed that enable multidimensional privacy control for consumers, to more effectively control their privacy, even while accepting some targeted marketing that provides time-savings, monetary savings, and other benefits. Agreements may involve smart contracts implemented on a blockchain, to provide time-limited access to marketing data, such as purchase histories recorded in receipts held by a digital wallet. The access may be specified in differing tiers of visibility, with certain classes of information withheld, and different types of recipients allowed or blocked. This permits consumers to intelligently select a trade-off between sharing information and receiving value resulting from that sharing, with the consumers in control of the specific type of information shared, and the types of entities that my receive particular information. Thus, privacy may be controlled in a multidimensional manner that is advantageous to consumers.

### CROSS-REFERENCE TO RELATED APPLICATION

This application claims the benefit of U.S. Provisional Application No. 62/714,652, filed Aug. 3, 2018, entitled “Multidimensional Privacy Control”, the entirety of which is hereby incorporated by reference herein.

### BACKGROUND

Target marketing activities may be profitable for retailers, and may even provide value for consumers in some situations, such as with discounts or reducing the need to search for certain items. However, target marketing activities may also be obtrusive and unwelcome. Some targeted marketing data collection efforts, for example, may identify certain shopping behaviors that implicate privacy concerns.

### SUMMARY

Systems and methods are disclosed that enable multidimensional privacy control for consumers, to more effectively control individual privacy, even while accepting some desired targeted marketing that provides time-savings, monetary savings, and other benefits. Agreements may involve smart contracts implemented on a blockchain, to provide time-limited access to marketing data, such as purchase histories recorded in receipts held by a digital wallet. The access may be specified in differing tiers of visibility, with certain classes of information withheld, and different types of recipients allowed or blocked. This permits consumers to intelligently select a trade-off between sharing information and receiving value resulting from that sharing, with the consumers in control of the specific type of information shared, and the types of entities that may receive particular information. Thus, privacy may be controlled in a multidimensional manner that is advantageous to consumers.

A disclosed system for multidimensional privacy control, implemented on at least one processor, comprises: a processor; and a computer-readable medium storing instructions that are operative when executed by the processor to: receive digital wallet information, the digital wallet information comprising purchase history information; score the digital wallet; based at least on the digital wallet score, offer a first value in exchange for mining a first level of visible digital wallet information; receive an acceptance of the offer; and generate a time-limited first smart contract based on the offered value and accepted offer.

### BRIEF DESCRIPTION OF THE DRAWINGS

The disclosed examples are described in detail below with reference to the accompanying drawing figures listed below:

FIG. 1 illustrates information sharing arrangements for a plurality of information types with a plurality of recipient entities;

FIG. 2 illustrates a collapse of two dimensions of information types into a single dimension for the notional display of FIG. 3;

FIG. 3 provides a notional illustration of dimensions of information sharing options (in addition to time-limits);

FIG. 4 illustrates a message sequence diagram for an embodiment of multidimensional privacy control;

FIG. 5 illustrates an exemplary functional arrangement for an embodiment of multidimensional privacy control;

FIGS. 6 and 7 show flow charts illustrating exemplary operations involved in multidimensional privacy control; and

FIG. 8 is a block diagram of an example computing device for implementing aspects disclosed herein.

Corresponding reference characters indicate corresponding parts throughout the drawings.

### DETAILED DESCRIPTION

A more detailed understanding may be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that may in isolation and out of context be read as absolute and therefore limiting, may only properly be read as being constructively preceded by a clause such as “In at least some embodiments, . . . ” For brevity and clarity of presentation, this implied leading clause is not repeated ad nauseum.

Targeted marketing activities may be obtrusive and unwelcome. Some targeted marketing data collection efforts, for example, may identify certain shopping behaviors that implicate privacy concerns. Thus, there exists a need for consumers to more effectively control their privacy, even while accepting some targeted marketing that provides time-savings, monetary savings, and other benefits to consumers.

Referring to the figures, examples of the disclosure enable systems and methods for multidimensional privacy control by consumers, to more effectively control their privacy, even while accepting some targeted marketing that provides time-savings, monetary savings, and other benefits. Agreements may involve smart contracts implemented on a blockchain, to provide time-limited access to marketing data, such as purchase histories recorded in receipts held by a digital wallet. The access may be specified in differing tiers of visibility, with certain classes of information withheld, and different types of recipients allowed or blocked. This permits consumers to intelligently select a trade-off between sharing information and receiving value resulting from that sharing, with the consumers in control of the specific type of information shared, and the types of entities that may receive particular information. Thus, privacy may be controlled in a multidimensional manner that is advantageous to consumers.

Trust management allows consumers to trade trust levels for rewards; the more trust the consumers place in the information recipient entities, demonstrated by allowing the transactions (including purchasing histories) to be visible, the more rewards the consumers may accrue. The trust management may be blockchain-enabled, leveraging smart contracts that grant controlled visibility into a consumer's digital wallet. Consumers may be offered various tiers of rewards in exchange for various tiers of visibility that is permitted into the digital wallets. For example, consumers may opt-in to receive full rewards (or perhaps additional digital currency upon transferring real funds) in exchange for full access to the consumer's account information and digital currency transactions. A second (lower visibility) tier will provide the consumer with a lesser reward, in exchange for providing recipient entities with a lesser amount of information. This tiered scheme may be extended to offer yet another tier of privacy/sharing, in which consumers block an even higher percentage (up to all, perhaps) of the transactions from marketing activities.

For example, a digital wallet may contain digital currency, receipts (showing purchase transaction histories), and rewards (such as coupons or special deals). One tier of visibility may grant a selected retailer full access to all transactions with all retailers, including competitors of the selected retailer with which the information is shared. Another tier may grant the selected retailer access to all transactions with that selected retailer and a limited set of specified competitor retailers. Yet another tier may grant the selected retailer access to only transactions with that selected retailer itself. And yet another tier may block at least some of the transactions with that selected retailer from marketing efforts even by that very same selected retailer.

Rewards may not be tokens on a blockchain but may be more valuable and practical to consumers who do not use cryptocurrency. For example, rewards for sharing visibility may include in-kind rewards such as special discount opportunities, and even cash deposits in a traditional bank account. Thus, the digital wallet need not be a cryptocurrency digital wallet but may instead be a consumer account that can record purchasing activities and store value for redemption, in conjunction with actual cash transactions. Both on-line and in-person retail purchase histories may be collected

Blockchains may be used, however, for recording consumer opt-in records (e.g., journaling) including implementing the information sharing access and rewards as smart contracts. Third parties may obtain read-only access, possibly in exchange for providing value to a data broker (who may pass along at least a portion to the consumers), or directly to the consumers themselves. Time limits may be enforced by the smart contracts, or by some other mechanism, for example 30 days, 90 days, a year, or any other suitable time frame. The time limits may enhance consumer privacy by preventing perpetually ongoing use as a default condition. Data may also be anonymized as part of the access, even further enhancing consumer privacy, while still providing information to marketers.

The exchange of value for receiving digital wallet information may be based at least partially on a digital wallet score. Digital wallets may be scored by, for example, demonstration of brand or retailer loyalty. Some consumers may be highly loyal to certain brands and thus purchase different categories of products, for example shoes and clothing bearing the same trademark or logo, at different retailers. Some consumers may be highly loyal to certain retailers (perhaps due to pricing or proximity to the consumers' residences), and thus may purchase different categories of products and even different brands, but typically from a single retailer. Some consumers' purchase history information, indicated within digital wallet information, may show a value-shopping pattern in which lowest cost products are purchased, largely independent of retailer and brand. Access to information permitting marketers to ascertain which consumer behaviors are most prevalent may have value, and consumers may hereby have an opportunity to receive value in exchange for providing visibility.

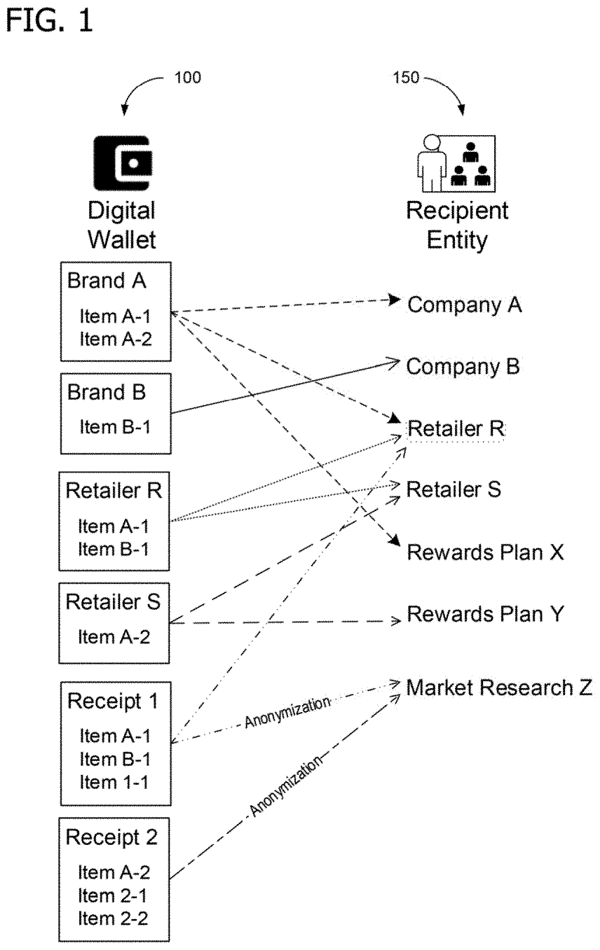

FIG. 1 illustrates information sharing arrangements for a plurality of information types in a digital wallet 100 with a set 150 of recipient entities. A recipient entity may be any organization or entity that may desire to obtain visibility into digital wallet information, such as target marketers. Recipient entities may include companies that market certain brands, retailers, rewards programs, market researchers, and others. Information available in digital wallet 100 includes purchase history information. As shown, this includes purchases of items A-1 and A-2 of Brand A, which are shared with Company A (that markets Brand A), and a purchase of an Item B-1 of Brand B, which is shared with Company B (that markets Brand B). Company A and Company B may place value on knowing the identities of their loyal customers, and may offer targeted coupons, in exchange. The coupons provide value to the consumer, who owns digital wallet 100, and thus this exchange of information for value is beneficial to both the consumer and Companies A and B.

Purchases of Brand A are also shared with Retailer R and a Rewards Plan X. The owner of digital wallet 100 has made a choice to opt-in to these visibility agreements, and they may need to be renewed upon expiration of associated time limits. Also, as can be seen in FIG. 1, the owner of digital wallet has agreed to share certain tracked purchases from Retailer R with Retailer R itself and with Retailer S, as well as sharing certain tracked purchases from Retailer S with Retailer S itself, and a Rewards Plan Y. A Receipt-1, presumably associated with a transaction purchased from Retailer R due to the coincidence of Items A-1 and B-1, is shared with Retailer R where the purchase was made. Receipt-1 also includes an Item 1-1 that is not specifically tracked by brand, but does reflect total spending at Retailer R. Receipt-1 is also shared with a Market Research Z entity, although anonymized first. A Receipt-2, presumably purchased from Retailer S due to the coincidence of Item A-2, is shared with Market Research Z entity, but may be anonymized first. As indicated, Receipt-2 also contains Items 2-1 and 2-2 that may not be tracked as brands, and the owner of digital wallet 100 may not have decided to share the entirety of Receipt-2 with Retailer S, for tracked marketing purposes.

With anonymized data, a recipient may have information regarding product brands and categories, but not consumer identity. Other types of data sanitization may be used, such as keeping the total purchase value of a receipt, but masking product categories and/or brands. It should also be understood that a single consumer may have multiple wallets, with different visibility and sharing arrangements unique to each wallet. For example, one digital wallet may be used for medical-related purchases, with little or no sharing, whereas another digital wallet may be used for entertainment purchases. Thus, the consumer may keep privacy regarding medical matters, while enjoying rewards and targeted discount offers for entertainment.

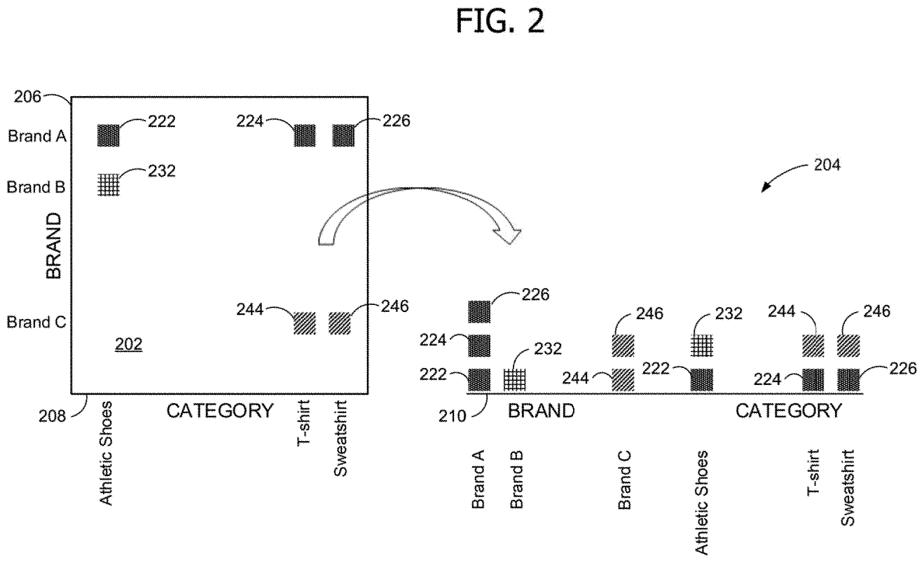

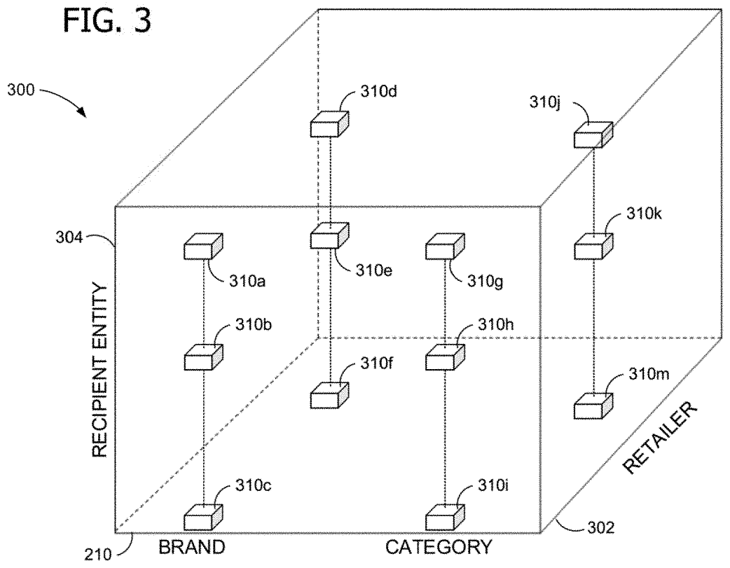

FIG. 2 illustrates a collapse of information types from a two-dimensional matrix 202 into a single one-dimensional histogram representation 204, to be used in the three-dimensional (3D) notional display of FIG. 3. The two axes of matrix 202 are Brand axis 206 and Category axis 208. Matrix 202 indicates that, during a covered period of purchase history information, a consumer has made three purchases of Brand A: athletic shoes 222, a t-shirt 224, and a sweatshirt 226. The consumer has also made on purchase of Brand B, athletic shoes 232, and two purchases of Brand C: a t-shirt 244, and a sweatshirt 246.

To facilitate the rendering of FIG. 3, the two axes 206 and 208 of matrix 202 are laid end-to-end, as axis 210 of representation 204. This necessitates rendering each of purchases 222, 224, 226, 232, 244, and 246 twice—once according to brand and once according to category. Purchases that are tracked as only one of brand and category, rather than both, may not require notional duplication along axis 210

FIG. 3 provides a notional display 300 having three dimensions of information sharing options. Time limits may be a notional fourth dimension. As can be seen in FIG. 3, the collapsed rendering of axis 210 (of FIG. 2) is used, along with axes Retailer 302 and Recipient Entity 304. For simplicity of illustration, display 300 illustrates a consumer having opted-in to share purchases of a particular brand and a particular entity, made at either of two retailers, with three different entities. Purchases 310a, 310b, and 310c are for a first brand, from a first retailer. Purchases 310d, 310e, and 310f are also for the first brand, but from a second retailer. Purchases 310g, 310h, and 310i are for a first product category, from the first retailer, and purchases 310j, 310k, and 310l are also for the first product category, from the second retailer. Purchases 310a, 310d, 310g, and 310j are shared with a first recipient entity. Purchases 310b, 310e, 310h, and 310k are shared with a second recipient entity. Purchases 310c, 310f, 310i, and 310m are shared with a third recipient entity. It should be understood, however, that any of recipient entity, brand, product category, retailer, and duration of visibility may be tailored. Thus, the privacy control is multidimensional.

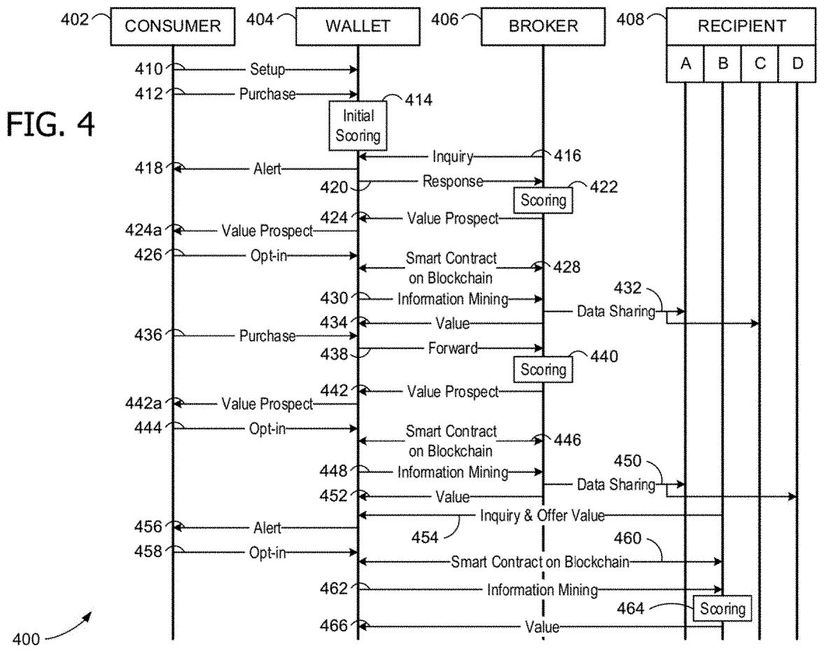

FIG. 4 illustrates a message sequence diagram 400 for an embodiment of multidimensional privacy control. A consumer 402 owns a digital wallet 404, which includes accumulated value (in the forms of digital currency, perhaps real currency, coupons and discounts, and other rewards having value) and may be implemented with one or more applications (apps) that run on one or more computing devices. Digital wallet 404 may be accessed by a data broker 406 that may facilitate a set of recipient entities 408 obtaining information from digital wallet 404. Data broker 406 may be an intermediary or third-party agent that is granted permission by a consumer to mine, score, store, and resell the digital wallet information. As illustrated, set of recipient entities 408 includes four recipients: A, B, C, and D. Each of recipients A-D may be retailers, reward programs, companies that sell certain brands, market research entities, and the like. It should be understood that, in some embodiments, any of data broker 406 and recipients 408 may communicate with digital wallet 404 to make offers, mine information, score information, and access information.

Consumer 402 sets up 410 wallet 404, and purchase history information 412 begins accumulating in wallet 404. Consumer 402 may also set up other wallets, for example by categories, such as one wallet for medical expenses, another for food, and another for entertainment, with privacy selections specified unique to each wallet. Wallet 404 is then initially scored 414, possibly using a generic algorithm, and scores sufficiently high to attract an inquiry 416 from broker 406. Consumer 402 is alerted 418 to inquiry 416, and wallet 404 responds 420, possibly subject to explicit permission from consumer 402. This response may take the form of a smart contract. Broker 406 then scores 422 information in digital wallet 404 according to a more specific algorithm that may relate to the particular type of marketing in which broker 406 engages. Based at least on the digital wallet score 422, broker 406 offers a value prospect 424 in exchange for an opportunity to mine visible digital wallet information. Value prospect 424 may include multiple levels of value in exchange for corresponding levels of visibility into digital wallet information.

Digital wallet 404 relays 424a the value prospect offer to consumer 402, who opts-in 426, with specified permissions for visibility, as indicated above. Consumer 402 may enter options into an app running on a local computing device, or use an interface to enter selections into a remote computing device operated by broker 406. Broker 406 then receives an acceptance of the offer, specifying a particular visibility option if more than one was included in the offer, via the creation of a smart contract 428. Smart contract 428 is possibly logged into a blockchain. A smart contract is a computerized transaction protocol that executes the terms of a contract. A blockchain-based smart contract is visible to users of the blockchain. Programming languages with various degrees of Turing-completeness that are built-in features of some blockchains make the creation of custom sophisticated logic possible. There are some notable examples of implementation of smart contracts: Bitcoin provides a Turing-incomplete scripting language that allows the creation of custom smart contracts on top of Bitcoin like multi-signature accounts, payment channels, escrows, time locks, atomic cross-chain trading, oracles, or multi-party lottery with no operator. Ethereum implements a nearly Turing-complete language on its blockchain, a prominent smart contract framework. RootStock (RSK) is a smart contract platform that is connected to the Bitcoin blockchain through sidechain technology. RSK is compatible with smart contracts created for Ethereum.

Information mining 430 may then commence. Broker 406 mines the visible digital wallet information under smart contract 428, during the time limit posed by smart contract 428. If earlier scoring 422 was subject to a smart contract, smart contract 428 may be time limited by the earlier-imposed time limit. Broker may then share data with selected ones of set of recipients 408 and return value 434 to wallet 404. Value 434 may be an in-kind reward, such as a cash reward, or product discounts, or perhaps even vouchers for free products.

As consumer 402 makes additional purchases, additional purchase history information 436 accumulates in wallet 404. If the prior agreements between consumer 402 (via wallet 404) and broker 406, which include response 420 and smart contract 428, are still valid and specify an ongoing data mining relationship, this new information is forwarded 438 to broker 406 for ongoing scoring 440. When broker 406 receives this new wallet information, an updated value prospect 442 may be sent to wallet 404 and relayed 442a to consumer 402 for opt-in 444. Broker 406 receives an acceptance of the offer via an implementation of a smart contract 446. Additional mining of digital wallet information may now commence under new smart contract 446, which may then be shared 450 with selected ones of set of recipients 408. Broker 406 then sends additional value 452 to wallet 404.

It should be understood that the activities thus described for broker 406 may instead be engaged in by recipient entity, such that a recipient entity (for example recipient entity B) engages directly with wallet 404. As illustrated, recipient entity B makes an inquiry and an offer of value 454 directly with wallet 404. Consumer 402 is alerted 456 to inquiry 454 and opts-in 458. Recipient B receives an acceptance of the offer when wallet 404 responds by negotiating to implement a smart contract 460. Information mining 462 may then commence during the time limit permitted by smart contract 462. Recipient B may then further score 464 the digital wallet information under smart contract 462. Inquiry 454 may have had value contingent upon the information meeting certain criteria that is likely to produce a certain score, which may be verified by scoring 464 the visible digital wallet information. Or scoring may be used to for recipient B to determine whether to make additional offers to consumer 402. If earlier scoring 422 was subject to a smart contract, smart contract 428 may be time limited by the earlier-imposed time limit. Recipient B returns value 466 to wallet 404.

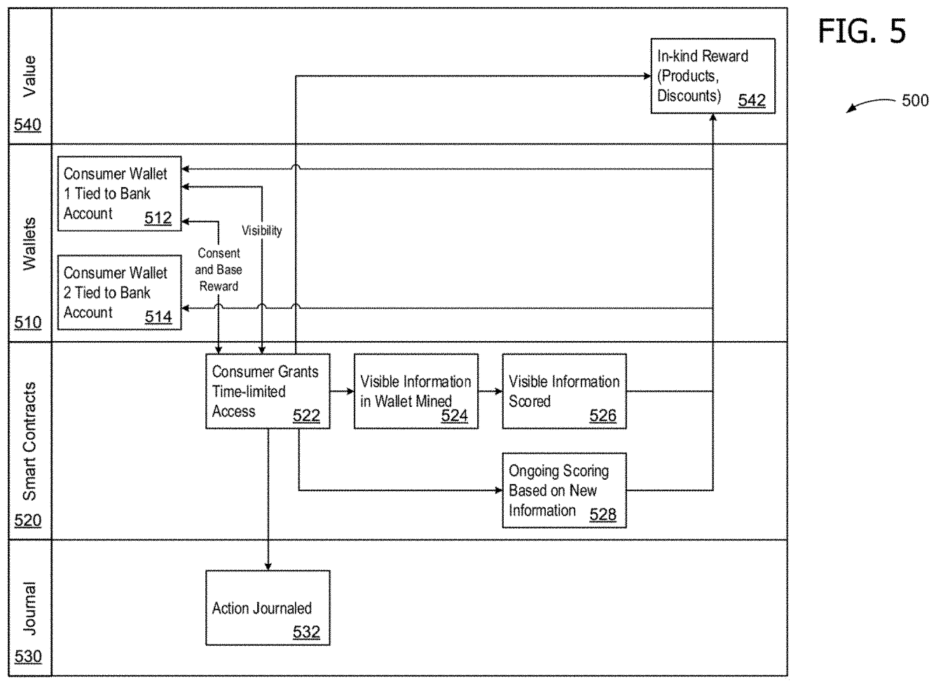

FIG. 5 illustrates an exemplary functional arrangement 500 for an embodiment of multidimensional privacy control. In Wallets activity 510, a consumer creates two wallets—a first wallet, in operation 512, and a second wallet, in operation 514. The different wallets may reflect different purchasing activity having different privacy concerns, such as medical, entertainment, or groceries. Consumers may perceive more privacy issues regarding medical spending, including prescription medicine and doctor visits, than the restaurants where they eat, the food products they purchase, or the movie theaters they visit. And some consumers may actually welcome targeted marketing in certain spending areas that provide valuable coupons or exclusive deals.

In Smart Contracts activity 520, the consumer grants time limited access in operation 522, which is reflected in Journal activity 530 by the action being journaled in a blockchain, in operation 532. The initial consent to grant visibility may result in an initial reward of value. The visible information, as specified by the consumer's preferences and implemented in a smart contract, is mined during operation 524 and scored in operation 526. If the consumer had opted-in to only a single sharing event, then this may be the primary activity under Smart Contracts activity 520. However, if the consumer had instead permitted an ongoing relationship through, then for the duration of the time limit, there may be ongoing scoring based on new incoming purchase history information, in operation 528.

The mining activity, as well as the ongoing relationship may be separate value prospects, and thus both scoring operations 526 and 528 may generate reward value for the consumer. These rewards may be returned to the first wallet 512 or even the second wallet 514, even if only the first wallet was mined for information. The rewards may be actual cash deposits in regular bank accounts. Additionally, reward value may be returned in Value activity 540 by depositing value into in-kind rewards, including free products, discounts, or other practical non-token values, in operation 542. The initial reward for the initial opt-in (granting consent) may be deposited by operation 522 into operation 542.

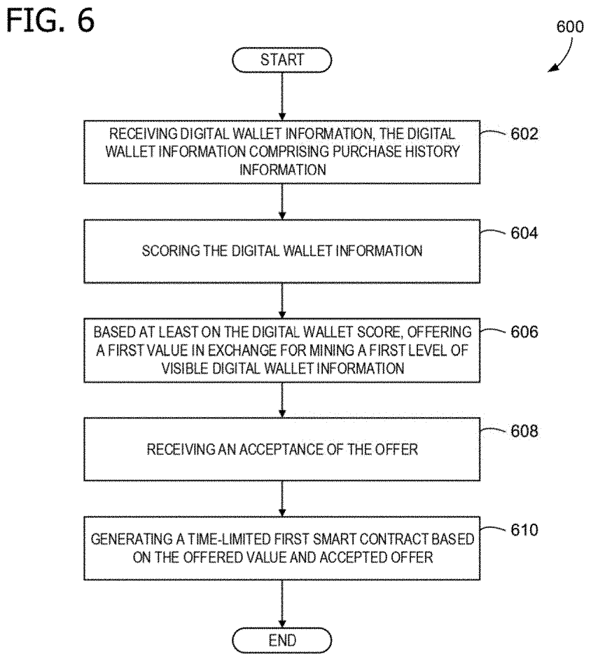

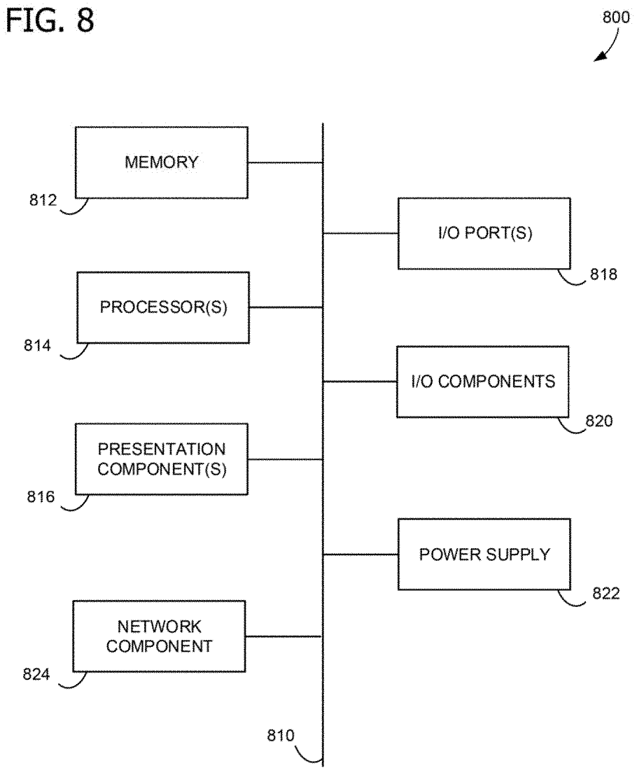

FIG. 6 shows a flow chart 600 illustrating exemplary operations involved in multidimensional privacy control. The operations illustrated in flow chart 600 may be performed by a compatible processing unit or computing node, such as the computing device of FIG. 8. Operation 602 includes receiving digital wallet information, the digital wallet information comprising purchase history information. Operation 604 includes scoring the digital wallet information. Scores may be calculated for the entire wallet or may be specific to a level of visibility. Operation 606 includes, based at least on the digital wallet score (of operation 604), offering a first value in exchange for mining a first level of visible digital wallet information. Operation 608 includes receiving an acceptance of the offer, and operation 610 includes generating a time-limited first smart contract based on the offered value and accepted offer.

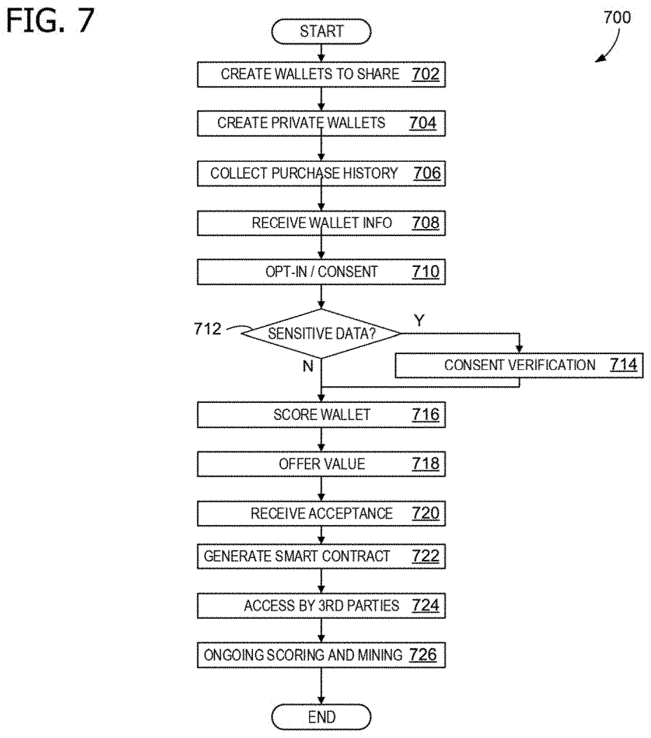

FIG. 7 shows a flow chart 700 illustrating exemplary operations involved in multidimensional privacy control. The operations illustrated in flow chart 700 may be performed by a compatible processing unit or computing node, such as the computing device of FIG. 8. In operation 702, a consumer creates one or more wallets to share, and in operation 704, the consumer creates one or more private wallets, which will likely not be mined. In operation 706, the wallets collect purchase history information, possibly through receipts from retailers. Transactions and items may be flagged at this point regarding whether they will be available for sharing with certain types of entities, if even shared at all. In operation 708 a data broker or marketing recipient entity receives digital wallet information, the digital wallet information comprising purchase history information. The received information at this point may be detailed or be fairly generic and lack details necessary for detailed target marketing mining, depending on how the initial inquiries and consent mechanisms are implemented. Receiving digital wallet information in operation 708 may be in accordance with a smart contract, such as a time-limited smart contract.

The consumer opts-in, or consents, in operation 710. The opt-in may occur through an app that is involved with running or executing operations within or involved with maintenance of the digital wallet. For some sensitive data, perhaps health-related data, or other data that may be associated with heightened privacy issues, it may be preferable to prompt the user for verification. Decision operation 712 includes determining whether a consent election includes sharing sensitive data, and operation 714 includes, based at least on a consent election including sharing sensitive data, generating an alert and receiving, from the user, verification of consent. Data may be sensitive data if it is of the type of data that qualifies for additional regulatory measures (for example, sensitive data as defined by the GDPR), or that has been otherwise identified as the type that is normally retained as private. Operation 716 includes scoring the digital wallet information. Separate scores may be calculated for the entire wallet and any differing levels of visibility that are considered. The scoring may involve determining brand and retailer loyalty, including retailers having both brick-and mortar presences and on-line eCommerce websites. In operation 718, a data broker or recipient entity may, based at least on the digital wallet score (of operation 716), offering a first value in exchange for mining a first level of visible digital wallet information. Operation 718 may also involve, based at least on the digital wallet score, offering a second value in exchange for mining a second level of visible digital wallet information, the second level of visible digital wallet information excluding at least a portion of the first level of visible digital wallet information. That is the second level of visible digital wallet information is a lower level of visibility because there is less visibility. Additionally, operation 718 may also involve based at least on the digital wallet score, offering a third value in exchange for mining a third level of visible digital wallet information, the third level of visible digital wallet information excluding at least a portion of the second level of visible digital wallet information. This third level of visible digital wallet information is even more restrictive than the second level of visible digital wallet information. Additional levels may also be offered.

Operation 720 includes receiving an acceptance of the offer. Receiving an acceptance of the offer comprises receiving an acceptance of one offer of the first offer and the second offer if offers were included for two levels of information, and if offers were included for three levels of information, receiving an acceptance of the offer comprises receiving an acceptance of one offer of the first offer, the second offer, and the third offer. The offer may be received in the form of a negotiation for a smart contract. Operation 722 includes generating a time-limited first smart contract based on the offered value and accepted offer. The smart contract may be implemented on a blockchain. Access by third parties, which may result in additional value being provided to the consumer, occurs during operation 724. So operation 724 includes offering access to the mined digital wallet information to a third party in accordance with a time-limited third smart contract. Ongoing scoring and mining occurs in operation 726.

In some examples, the operations illustrated in the flowcharts may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements. While the aspects of the disclosure have been described in terms of various examples with their associated operations, a person skilled in the art would appreciate that a combination of operations from any number of different examples or some reordering is also within scope of the aspects of the disclosure.

### Exemplary Operating Environment

FIG. 8 is a block diagram of an example computing device 800 for implementing aspects disclosed herein and is designated generally as computing device 800. Computing device 800 is one example of a suitable computing environment and is not intended to suggest any limitation as to the scope of use or functionality of the invention. Neither should the computing device 800 be interpreted as having any dependency or requirement relating to any one or combination of components/modules illustrated.

The examples and embodiments disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments, where tasks are performed by remote-processing devices that are linked through a communications network.

Computing device 800 includes a bus 810 that directly or indirectly couples the following devices: memory 812, one or more processors 814, one or more presentation components 816, input/output (I/O) ports 818, I/O components 820, a power supply 822, and a network component 824. Computing device 800 should not be interpreted as having any dependency or requirement related to any single component or combination of components illustrated therein. While computing device 800 is depicted as a seemingly single device, multiple computing devices 800 may work together and share the depicted device resources. That is, one or more computer storage devices having computer-executable instructions stored thereon may perform operations disclosed herein. For example, memory 812 may be distributed across multiple devices, processor(s) 814 may provide housed on different devices, and so on.

Bus 810 represents what may be one or more busses (such as an address bus, data bus, or a combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. Such is the nature of the art, and the diagram of FIG. 8 is merely illustrative of an exemplary computing device that can be used in connection with one or more embodiments. Distinction is not made between such categories as “workstation,” “server,” “laptop,” “hand-held device,” etc., as all are contemplated within the scope of FIG. 8 and the references herein to a “computing device.”

Memory 812 may include any of the computer-readable media discussed herein. Memory 812 may be used to store and access instructions configured to carry out the various operations disclosed herein. In some examples, memory 812 includes computer storage media in the form of volatile and/or nonvolatile memory, removable or non-removable memory, data disks in virtual environments, or a combination thereof

Processor(s) 814 may include any quantity of processing units that read data from various entities, such as memory 812 or I/O components 820. Specifically, processor(s) 814 are programmed to execute computer-executable instructions for implementing aspects of the disclosure. The instructions may be performed by the processor, by multiple processors within the computing device 800, or by a processor external to the client computing device 800. In some examples, the processor(s) 814 are programmed to execute instructions such as those illustrated in the flowcharts discussed below and depicted in the accompanying drawings. Moreover, in some examples, the processor(s) 814 represent an implementation of analog techniques to perform the operations described herein. For example, the operations may be performed by an analog client computing device 800 and/or a digital client computing device 800.

Presentation component(s) 816 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 800, across a wired connection, or in other ways.

Ports 818 allow computing device 800 to be logically coupled to other devices including I/O components 820, some of which may be built in. Examples I/O components 820 include, for example but without limitation, a microphone, keyboard, mouse, joystick, game pad, satellite dish, scanner, printer, wireless device, etc.

In some examples, the network component 824 includes a network interface card and/or computer-executable instructions (e.g., a driver) for operating the network interface card. Communication between the computing device 800 and other devices may occur using any protocol or mechanism over any wired or wireless connection. In some examples, the network component 824 is operable to communicate data over public, private, or hybrid (public and private) using a transfer protocol, between devices wirelessly using short range communication technologies (e.g., near-field communication (NFC), BLUETOOTH® branded communications, or the like), or a combination thereof.

Although described in connection with an example computing device 800, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media typically embody computer readable instructions, data structures, program modules, or the like in a modulated data signal such as a carrier wave or other transport mechanism and include any information delivery media.

### Exemplary Operating Methods and Systems

An exemplary system for multidimensional privacy control, implemented on at least one processor, comprises: a processor; and a computer-readable medium storing instructions that are operative when executed by the processor to: receive digital wallet information, the digital wallet information comprising purchase history information; score the digital wallet; based at least on the digital wallet score, offer a first value in exchange for mining a first level of visible digital wallet information; receive an acceptance of the offer; and generate a time-limited first smart contract based on the offered value and accepted offer.

An exemplary method for multidimensional privacy control, implemented on at least one processor, comprises: receiving digital wallet information, the digital wallet information comprising purchase history information; scoring the digital wallet; based at least on the digital wallet score, offering a first value in exchange for mining a first level of visible digital wallet information; receiving an acceptance of the offer; and generating a time-limited first smart contract based on the offered value and accepted offer.

One or more exemplary computer storage devices having a first computer-executable instructions stored thereon for multidimensional privacy control, which, on execution by a computer, cause the computer to perform operations which may comprise: receiving digital wallet information, the digital wallet information comprising purchase history information; scoring the digital wallet; based at least on the digital wallet score, offering a first value in exchange for mining a first level of visible digital wallet information; based at least on the digital wallet score, offering a second value in exchange for mining a second level of visible digital wallet information, the second level of visible digital wallet information excluding at least a portion of the first level of visible digital wallet information; receiving an acceptance of an offer, wherein receiving an acceptance of an offer comprises receiving an acceptance of one offer of the first offer and the second offer; and generating a time-limited first smart contract based on the offered value and accepted offer.

Alternatively, or in addition to the other examples described herein, examples include any combination of the following:
receiving digital wallet information comprises receiving digital wallet information in accordance with a second smart contract;
the first smart contract is implemented on a blockchain;
the instructions are further operative to: offer access to the mined digital wallet information to a third party in accordance with a time-limited third smart contract;
the instructions are further operative to: based at least on the digital wallet score, offer a second value in exchange for mining a second level of visible digital wallet information, the second level of visible digital wallet information excluding at least a portion of the first level of visible digital wallet information, and wherein receiving an acceptance of the offer comprises receiving an acceptance of one offer of the first offer and the second offer;
the instructions are further operative to: based at least on the digital wallet score, offer a third value in exchange for mining a third level of visible digital wallet information, the third level of visible digital wallet information excluding at least a portion of the second level of visible digital wallet information, and wherein receiving an acceptance of the offer comprises receiving an acceptance of one offer of the first offer, the second offer, and the third offer; and
the first offered value comprises an in-kind reward.

The order of execution or performance of the operations in examples of the disclosure illustrated and described herein may not be essential, and thus may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense. While the disclosure is susceptible to various modifications and alternative constructions, certain illustrated examples thereof are shown in the drawings and have been described above in detail. It should be understood, however, that there is no intention to limit the disclosure to the specific forms disclosed, but on the contrary, the intention is to cover all modifications, alternative constructions, and equivalents falling within the spirit and scope of the disclosure.

What is claimed is:

1. A system for multidimensional privacy control, implemented on at least one processor, the system comprising:
a processor; and
a computer-readable medium storing instructions that are operative when executed by the processor to:
receive digital wallet information, the digital wallet information comprising purchase history information;
score the digital wallet information;
based at least on the digital wallet score, offer a first value in exchange for mining a first level of visible digital wallet information;
receive an acceptance of the offer; and
generate a time-limited first smart contract based on the offered value and accepted offer.

2. The system of claim 1 wherein receiving digital wallet information comprises receiving digital wallet information in accordance with a second smart contract.

3. The system of claim 1 wherein the first smart contract is implemented on a blockchain.

4. The system of claim 1 wherein the instructions are further operative to:
offer access to the mined digital wallet information to a third party in accordance with a time-limited third smart contract.

5. The system of claim 1 wherein the instructions are further operative to:
based at least on the digital wallet score, offer a second value in exchange for mining a second level of visible digital wallet information, the second level of visible digital wallet information excluding at least a portion of the first level of visible digital wallet information, and
wherein receiving an acceptance of the offer comprises receiving an acceptance of one offer of the first offer and the second offer.

6. The system of claim 5 wherein the instructions are further operative to:
based at least on the digital wallet score, offer a third value in exchange for mining a third level of visible digital wallet information, the third level of visible digital wallet information excluding at least a portion of the second level of visible digital wallet information, and
wherein receiving an acceptance of the offer comprises receiving an acceptance of one offer of the first offer, the second offer, and the third offer.

7. The system of claim 1 wherein the instructions are further operative to:
determine whether a consent election includes sharing sensitive data, and
based at least on the consent election including sharing sensitive data, generating an alert.

8. A method for multidimensional privacy control, implemented on at least one processor, the method comprising:
receiving digital wallet information, the digital wallet information comprising purchase history information;
scoring the digital wallet information;
based at least on the digital wallet score, offering a first value in exchange for mining a first level of visible digital wallet information;
receiving an acceptance of the offer; and
generating a time-limited first smart contract based on the offered value and accepted offer.

9. The method of claim 8 wherein receiving digital wallet information comprises receiving digital wallet information in accordance with a second smart contract.

10. The method of claim 8 wherein the first smart contract is implemented on a blockchain.

11. The method of claim 8 further comprising:
offering access to the mined digital wallet information to a third party in accordance with a time-limited third smart contract.

12. The method of claim 8 further comprising:
based at least on the digital wallet score, offering a second value in exchange for mining a second level of visible digital wallet information, the second level of visible digital wallet information excluding at least a portion of the first level of visible digital wallet information, and
wherein receiving an acceptance of the offer comprises receiving an acceptance of one offer of the first offer and the second offer.

13. The method of claim 12 further comprising:
based at least on the digital wallet score, offering a third value in exchange for mining a third level of visible digital wallet information, the third level of visible digital wallet information excluding at least a portion of the second level of visible digital wallet information, and
wherein receiving an acceptance of the offer comprises receiving an acceptance of one offer of the first offer, the second offer, and the third offer.

14. The method of claim 8 further comprising:
determining whether a consent election includes sharing sensitive data, and
based at least on the consent election including sharing sensitive data, generating an alert.

15. One or more computer storage devices having computer-executable instructions stored thereon for multidimensional privacy control, which, on execution by a computer, cause the computer to perform operations comprising:
receiving digital wallet information, the digital wallet information comprising purchase history information;
scoring the digital wallet information;
based at least on the digital wallet score, offering a first value in exchange for mining a first level of visible digital wallet information;
based at least on the digital wallet score, offering a second value in exchange for mining a second level of visible digital wallet information, the second level of visible digital wallet information excluding at least a portion of the first level of visible digital wallet information;
receiving an acceptance of an offer, wherein receiving an acceptance of an offer comprises receiving an acceptance of one offer of the first offer and the second offer; and
generating a time-limited first smart contract based on the offered value and accepted offer.

16. The one or more computer storage devices of claim 15 wherein receiving digital wallet information comprises receiving digital wallet information in accordance with a second smart contract.

17. The one or more computer storage devices of claim 15 wherein the first smart contract is implemented on a blockchain.

18. The one or more computer storage devices of claim 15 wherein the operations further comprise:
offering access to the mined digital wallet information to a third party in accordance with a time-limited third smart contract.

19. The one or more computer storage devices of claim 15 wherein the operations further comprise:
based at least on the digital wallet score, offering a third value in exchange for mining a third level of visible digital wallet information, the third level of visible digital wallet information excluding at least a portion of the second level of visible digital wallet information, and
wherein receiving an acceptance of the offer comprises receiving an acceptance of one offer of the first offer, the second offer, and the third offer.

20. The one or more computer storage devices of claim 15 wherein the first offered value comprises an in-kind reward.
